(19) United States
(12) Patent Application Publication
(10) Pub. No.: US 2023/0038486 A1
(43) Pub. Date: Feb. 9, 2023

(54) TEST FACILITY INFRASTRUCTURE CONTROL AND CONFIGURATION

(71) Applicant: The Regents of the University of Michigan, Ann Arbor, MI (US)

(72) Inventors: TYLER S. WORMAN, Ypsilanti, MI (US); GREGORY J. MCGUIRE, Ann Arbor, MI (US)

(21) Appl. No.: 17/797,418

(22) PCT Filed: Feb. 9, 2021
(86) PCT No.: PCT/US2021/017230

§ 371 Date: Aug. 3, 2022

Related U.S. Application Data
(60) Provisional application No. 62/972,139, filed on Feb. 10, 2020.

(51) Int. Cl. G05B 17/02; G01M 17/007; G07C 5/00

(52) U.S. Cl. CPC G05B 17/02; G01M 17/007; G07C 5/008; G08G 1/07

(57) ABSTRACT

A test facility infrastructure control system and method for controlling test environment devices located at a test facility, including: at least one test facility control server that is communicatively coupled to a test facility gateway server that is configured to receive a test configuration to be used in carrying out vehicle testing at the test facility; test environment devices located at the test facility; and one or more test environment controllers; wherein the at least one test facility control server is configured to: receive a test environment control request from the test facility gateway server that specifies one or more test environment devices and includes test environment control instructions that specify a test operation or state of the specified test environment device(s); and send a test environment control message to a selected test environment controller, which causes the specified test environment device to operate according to the test configuration.

### TECHNICAL FIELD

This invention relates to methods, systems, and devices for configuring and controlling the test environment at a vehicle test facility.

### BACKGROUND

With the advent of autonomous vehicles, testing of vehicle operations has become much more prominent. Vehicle testing may be carried out at a dedicated vehicle proving ground, such as Mcity™ in Ann Arbor, Mich., or at one or more public or private roadways. Such testing facilities may have one or more devices that are controllable, such as traffic signals and boom barriers. A test user may experience difficulties of challenges while configuring the testing facility for vehicle testing, especially when the vehicle testing requires programming or configuring a variety of different devices that each have a different configuration process. Moreover, there is a need for a test user to be able to define and save a test configuration so that vehicle testing may more easily be reproducible and repeatable.

### SUMMARY

According to one aspect of the invention, there is provided a test facility infrastructure control system for controlling test environment devices located at a test facility, including: at least one test facility control server that includes at least one processor and memory storing computer instructions, wherein the at least one test facility control server is communicatively coupled to a test facility gateway server that is configured to receive test facility configuration information that specifies a test configuration to be used in carrying out vehicle testing at the test facility; a plurality of test environment devices located at the test facility, each of the test environment devices being operable to change one or more vehicle traffic or environmental conditions used during the vehicle testing; and one or more test environment controllers, each of which is communicatively coupled to at least one of the test environment devices, and each of which is communicatively coupled to the at least one test facility control server; wherein, when the computer instructions are executed by the at least one processor, the at least one test facility control server is configured to: (i) receive a test environment control request from the test facility gateway server, wherein the test environment control request specifies at least one of the test environment devices and includes test environment control instructions that specify a test operation or state of the specified test environment device, and wherein the test environment control instructions are generated by the test facility gateway server based on the test configuration; and (ii) send a test environment control message to a selected one of the one or more test environment controllers, wherein the test environment control message specifies the test operation or state of the specified test environment device, and wherein the selected test environment controller is configured to, in response to receiving the test environment control message, cause the specified test environment device to operate according to the test operation or state so as to operate according to the test configuration.

According to various embodiments, the method may further include any one of the following features or any technically-feasible combination of some or all of the features:
the test facility gateway server provides a test configuration application programming interface (API) that is used by a client device of a test facility user to specify the test configuration;
the client device includes a test configuration client application, wherein the test configuration client application provides a graphical user interface (GUI) that is usable by the test facility user for specifying certain properties or portions of the test configuration;
at least one of the one or more test environment controllers is a traffic signal controller and at least one of the plurality of test environment devices is a traffic signal that is controllable by the traffic signal controller;
the test configuration specifies a traffic signal state of the traffic signal, wherein the test environment control message specifies the traffic signal state of the traffic signal, and wherein, when the traffic signal controller receives the test environment control message, the traffic signal controller causes the traffic signal to operate according to the traffic signal state;
the test facility infrastructure control system further includes a roadside unit (RSU) that is communicatively coupled to the test facility control system and that is capable of short-range wireless communications (SRWCs), and wherein the RSU receives vehicle state information from a test vehicle that is being tested at the test facility and sends the vehicle state information to the test facility control system;
the vehicle state information is sent to a client device of a test facility user and presented to the test facility user using a human-machine interface (HMI) of the client device;
the test facility gateway server is part of a test facility gateway, and wherein the test facility gateway records test facility state information into a database;
the test facility state information is received at the test facility gateway from the at least one test facility control server, and wherein the database is a distributed key store that stores key-value pairs;
at least one of the plurality of test environment devices is a traffic control device that is retrofitted with an internet of things (IoT) device so as to enable the retrofitted traffic control device to be remotely controllable by the test facility infrastructure control system;
at least one of the plurality of test environment devices is a test-anomaly device that is used to introduce anomalous conditions into the test facility;
the test-anomaly device is a robotic dummy that is deployable to a portion of a road within the test facility;
at least one of the plurality of test environment devices is an environmental control device that is operable to change an environmental factor or condition of the test facility;
the environmental control device is a streetlight that provides ambient lighting to a portion of the test facility;
at least one of the plurality of test environment devices is a schedule-based test environment device that operates according to a predetermined or specified schedule that is specified at least in part by the test configuration; and/or
at least one of the plurality of test environment devices is an event-based test environment device that operates in response to detection of a trigger that is specified at least in part by the test configuration.

According to another aspect of the invention, there is provided a method of controlling a test environment device located at a test facility. The method includes: receiving, at a test facility gateway server, test facility configuration information that specifies a test configuration to be used in carrying out vehicle testing at the test facility; generating a test environment control request, wherein the test environment control request specifies a test environment device and includes test environment control instructions that specify a test operation or state of the specified test environment device, and wherein the test environment control instructions are generated by the test facility gateway server based on the test configuration; receiving, at a test facility control server, the test environment control request; and in response to receiving the test environment control request at the test facility control server, sending a test environment control message from the test facility control server to a test environment controller, wherein the test environment control message specifies the test operation or state of the specified test environment device, and wherein the test environment controller is configured to, in response to receiving the test environment control message, cause the specified test environment device to operate according to the test operation or state so as to operate according to the test configuration.

### BRIEF DESCRIPTION OF THE DRAWINGS

One or more aspects of the disclosure will hereinafter be described in conjunction with the appended drawings, wherein like designations denote like elements, and wherein

FIG. 1 is a block diagram of an exemplary communications system that includes a test facility infrastructure control system;

FIG. 2 is a block diagram of a test facility control system according to one embodiment; and

FIG. 3 is a flowchart of a method of controlling a test environment device of a test facility based on a test configuration according to one embodiment.

### DETAILED DESCRIPTION

The system and method described herein enables control and configuration of one or more test environment devices of a test facility based on a test configuration. In at least some embodiments, the test facility is a facility used for testing vehicles and, in one embodiment, the test facility is a facility used for testing automobiles. A test facility infrastructure control system is used to control and configure a plurality of test environment devices that are located at the test facility. Each of the test environment devices is operable to change one or more vehicle traffic or environmental conditions used during the vehicle testing. For example, a first test environment device is a traffic signal that is operable to change a traffic light, such as from green to red. As another example, a second test environment device is a gate that is operable to change between a road-obstructing position (or closed position) and a non-road-obstructing position (or open position). The test environment devices are communicatively coupled to at least one test environment controller, each of which is used to control the operation of test environment device(s). Each test environment controller is communicatively coupled to a test facility control server of the test facility control system, which is configured to receive test facility configuration information that specifies a test configuration to be used in carrying out vehicle testing at the test facility. The test facility control system is used to send messages to the test environment controllers that then cause the test environment controllers to control the operation of the test environment devices according to the test configuration.

The test configuration is received from a test facility gateway that is communicatively coupled to the test facility control system. In at least some embodiments, the test configuration specifies a plurality of states or operations of one or more test environment devices; however, in one embodiment, the test configuration specifies a single state or operation of one of the test environment devices. The test facility gateway is configured to receive test configuration information from a test facility user. In at least one embodiment, the test facility gateway, through use of one or more test facility gateway servers, provides an application programming interface (API) that enables the test facility user (through a client device) to readily specify the test configuration and this API is referred to as the test configuration API. In one embodiment, the test facility user uses a personal computer (e.g., laptop, smartphone, desktop computer) or other client device to input information specifying the test configuration, which is then sent to the test facility gateway using the test configuration API. In one embodiment, the client device of the test facility user includes a test configuration client application, which is a computer application that may be a web application accessible using an Internet browser or an application installed to the client device, for example. According to one embodiment, the test configuration client application includes a graphical user interface (GUI) that enables the test facility user to specify the test configuration through providing input into the GUI, such as through various graphical user input elements (e.g., checkboxes, text fields, text boxes, selectable graphics, drag and drop elements). The test configuration client application then generates one or more test facility configuration messages based on the test facility user input and sends these test facility configuration messages to the test facility gateway via the API. Thus, in such embodiments, the test configuration client application enables the test facility user to intelligibly specify a test configuration that will be automatically executed by the system through use of the test facility gateway and the test facility control system.

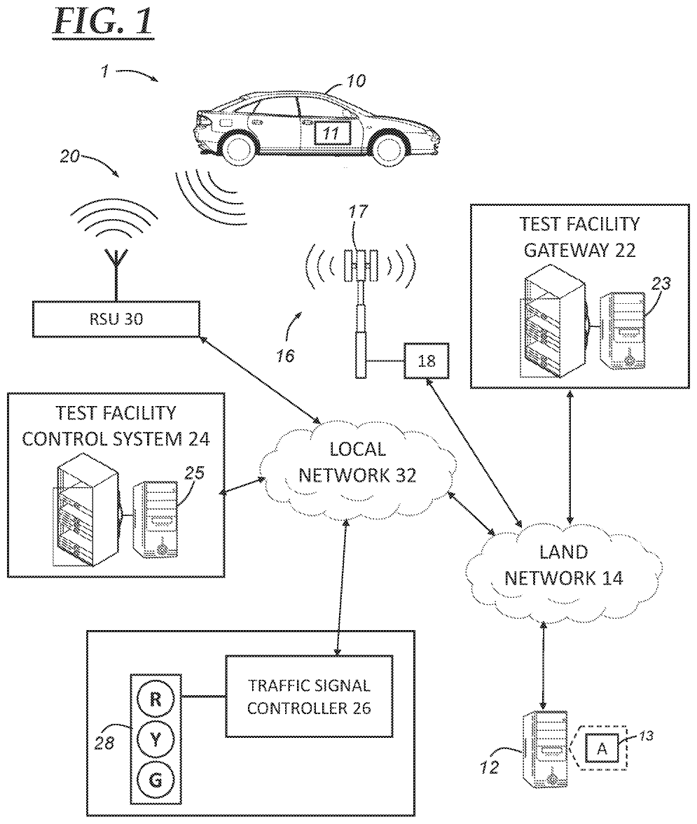

With reference to FIG. 1, there is shown a there is shown an operating environment that comprises a communications system 1 that includes a test vehicle 10 having vehicle electronics 11, a client device 12, a land network 14, a wireless carrier system 16, and a test facility infrastructure control system 20 that can be used to implement the method disclosed herein. The test facility infrastructure control system 20 includes a test facility gateway 22, a test facility control system 24, a plurality of test facility controllers (which is represented in FIG. 1 by a traffic signal controller 26), a plurality of test environment devices (which is represented in FIG. 1 by a traffic signal 28 that is depicted as a traffic light), roadside unit (RSU) 30, and local test facility network 32. The arrows that are shown in FIG. 1 between the various components indicate an electronic data communication path over which electronic data or information may be communicated. It should be understood that the disclosed method can be used with any number of different systems and is not specifically limited to the operating environment shown here. FIG. 1 shows one potential embodiment of a test facility infrastructure control system; however, it should be appreciated that other architectures, setups, configurations, devices, etc., may be used.

The land network 14 may be a conventional data communications network that provides connectivity to between remote devices, and that can be used to connect the wireless carrier system 16 to one or more networks or devices that are remote to one another, such as the test facility control system 24 and the test facility gateway 22. In one embodiment, the land network 14 includes a packet-switched data communications network that is used to provide access to Internet infrastructure. One or more segments of the land network 14 may be implemented through the use of a standard wired network, a fiber or other optical network, a cable network, power lines, other wireless networks such as wireless local area networks (WLANs), or networks providing broadband wireless access (BWA), or any combination thereof.

The wireless carrier system 16 may be any suitable cellular communications system, such as a wireless telephone system. The wireless carrier system 16 is shown as including a cellular tower 17; however, the wireless carrier system 16 may include additional cellular towers as well as one or more of the following components (e.g., depending on the cellular technology): base transceiver stations, mobile switching centers, base station controllers, evolved nodes (e.g., eNodeBs), mobility management entities (MMEs), serving and PGN gateways, etc., as well as any other networking components required to connect the wireless carrier system 16 with the land network 14 or to connect the wireless carrier system with user equipment (UEs, e.g., which include telematics equipment in the test vehicle electronics 11 of the test vehicle 10), all of which is indicated generally at 16. The wireless carrier system 16 may be configured to implement any of a variety of suitable communications technologies, including for example GSM/GPRS technology, CDMA or CDMA2000 technology, LTE technology, etc. In general, the wireless carrier system 16, its components, the arrangement of its components, the interaction between the components, etc. is generally known in the art.

The local test facility network 32 (or local network 32 for short) is a part of the test facility infrastructure control system 20, and is a local network that is used to carry out communications between various components of the test facility infrastructure control system 20, such as the RSU 30, the test facility control system 24, and the traffic signal controller 26. The local network 32 can include wired communications and/or wireless communications, such as any of a variety of V2X communications, including cellular and/or SRWCs. In at least some embodiments, the local network 32 is a local area network (LAN) and can include one or more routers and/or modems. The local network 32 is also connected to the land network 14, and this connection can be used by the local network 32 for providing remote connectivity to one or more servers or other devices connected to the local network 32, such as devices of the test facility infrastructure control system 20; in this way, the system may provide, for example, a connection between the test environment control system 24 and the test facility gateway 22.

The test vehicle 10 is a vehicle under test that is to be tested at the test facility using the test facility infrastructure control system 20. The test vehicle 10 is depicted in the illustrated embodiment as a passenger car, but it should be appreciated that any other vehicle including motorcycles, trucks, sports utility vehicles (SUVs), recreational vehicles (RVs), bicycles, unmanned aerial vehicles (UAVs) (e.g., quadcopter drones) other vehicles or mobility devices that can be used on a roadway or sidewalk and/or by pedestrians, etc., can also be used as the test vehicle 10. In a particular embodiment, the test vehicle 10 is an automated vehicle and, in a particular scenario, the automated functionality of the test vehicle 10 is to be tested. The test vehicle 10 includes test vehicle electronics 11 and, in some embodiments, the test vehicle electronics 11 include a wireless communications device that is used to carry out wireless communications. In one embodiment, the wireless communications device includes short-range wireless communications (SRWC) circuitry that enables the vehicle to send and receive wireless messages using one or more SRWC technologies, such as Wi-Fi™, Bluetooth™, IEEE 802.11p, other vehicle to infrastructure (V2I) communications, vehicle to vehicle (V2V) communications, other vehicle to everything (V2X) communications, etc. In one embodiment, the test vehicle 10 sends basic safety messages (BSMs) (e.g., a BSM per second) to the RSU 30 and/or to other device(s) of the test facility infrastructure control system 20 and/or communications system 1. In one embodiment, the BSMs are sent by the vehicle using SAE J2735.

The client device 12 is a computer that is configured to receive input from a test facility user and to send test facility configuration messages to the test facility gateway 22. The test facility configuration messages each specify at least a part of a test configuration that is to be implemented at the test facility through use of the test facility infrastructure control system 22. The client device 12 can be a desktop computer, a laptop, a smartphone, a tablet, other personal mobile computer, or other suitable computer. The client device includes at least one processor and memory having computer instructions. The client device 12 includes a test configuration client application 13, which can be a web application or an application installed onto the client device 12. In embodiments where the test configuration client application 13 is a web application, the application 13 may be accessible via an Internet browser, and this web application may be hosted by the test facility gateway 22. In other embodiments, the test configuration client application 13 is installed on the client device and, in such embodiments, this application may be an application that is developed by the client (or test facility user), or may be an application that is downloaded and installed by the client or test facility user. For example, in one embodiment, the test facility user (or other user) may develop a computer application that communicates with the test facility gateway 22 via the test configuration API. The computer instructions can include instructions for executing or carrying out the test configuration client application 13 and, in some embodiments, such as when the application 13 is a web application, the computer instructions may be received via TCP/IP, UDP, or other remote network protocol and may be in the form of HMTL, Javascript, or other browser-compatible instructions. In any event, according to some embodiments, the test configuration client application 13 includes a graphical user interface (GUI) that includes various graphical user input elements (e.g., checkboxes, text fields, text boxes, selectable graphics, drag and drop elements). In such embodiments, the test configuration client application 13 generates one or more test facility configuration messages based on the inputs received via the graphical user input elements.

In one embodiment, the test configuration client application 13 and/or the test facility gateway 22 is configured to store test configurations as pre-stored test configuration data so that the stored test configurations may later be retrieved and used by the test facility infrastructure control system 20 for carrying out testing. The test configurations may be specified by a particular test facility user and associated with an account of the test facility user, which may be managed by the test facility gateway 22. In at least some scenarios, by storing a test configuration as pre-stored test configuration data, the test facility infrastructure control system 20 allows the test facility user to repeat tests without having to re-specify the test configuration. In one embodiment, the test facility user can specify individual requests (or test facility configuration messages) to test certain functionality or aspects of the test facility. In one scenario, the test facility user may want to confirm certain functionality of the test facility prior to actually running a full test. Thus, the test facility user can specify individual test facility configuration messages that will be carried out by the test facility infrastructure control system 20. These individual requests may cause the requested functionality to be carried out according to a timed schedule or at a particular time, including immediately in response to the test facility infrastructure control system 20 receiving the request. As an example, the test facility user may want to test turning off all streetlights at sunrise and this can be specified in a test facility configuration message that is sent from the client device 12 to the test facility gateway 22.

The test facility gateway 22 includes one or more test facility gateway servers 23 and is used to receive a test configuration from the client device 12 and to send information representing (or based on) the test configuration to the test facility control system 24. The test facility gateway 22 is shown as being connected to the land network 14, and can be located remotely from the client device 12 and/or the test facility control system 24. In one embodiment, the test facility gateway 22 and the test facility control system 24 are co-located and, in a particular embodiment, the test facility gateway 22 and the test facility control system 24 are incorporated into (or implemented by) a single computer that includes at least one test facility gateway server and at least one test facility control server, which may be embodied as software modules on the single computer. However, in at least some embodiments, the test facility gateway 22 and the test facility control system 24 are located remotely from one another and are connected via the land network 14 and the local network 32.

The test facility control system 24 includes one or more test facility control servers 25 and is used to receive test environment control requests from the test facility gateway 22 and to send test environment control messages to particular test environment controllers. A test environment control request specifies at least one of the test environment devices and includes test environment control instructions that specify a test operation or state of the specified test environment device. A test environment control message specifies the test operation or state of the test environment device that is specified in a test environment control request. In at least some embodiments, when a test environment controller receives a test environment control message, then the test environment controller causes the specified test environment device to operate according to the test operation or state, which results in the test environment device operating according to the test configuration information received initially from the client device. Each of test facility gateway server(s) and/or the test facility control server(s) include at least one processor and memory storing computer instructions that, when executed by the at least one processor, causes the server to carry out the associated functionality discussed herein. Also, it should be appreciated that, although only a single server is shown for each of the test facility gateway 22 and the test facility control system 24, each of the test facility gateway 22 and the test facility control system 24 may include a plurality of servers, each of which carries out the same and/or different functionality.

In some instances, the test facility user may desire to have certain operations or functionality be carried out by a test environment device, but the associated test environment controller may not be configured to carry out the specified operations or functionality. That is, the test environment controller is not able to be directly controlled so as to achieve the desired functionality. For example, the test facility user may request that a traffic signal remain in the yellow phase (i.e., emitting a yellow light) for a long period of time (e.g., 10 minutes), but existing traffic signal systems (including a traffic signal controller) may not be manufactured so as to achieve such functionality. In such instances, for example, the test facility control system 24 is able to identify the requested functionality received from the test facility gateway 22, and then determine one or more operations to carry out (e.g., one or more test environment control messages to generate and send) so as to cause the test environment controller to carry out the requested functionality. Thus, according to at least some embodiments, the test facility control system 24 includes software that is specifically configured to be able to cause the test environment controller to achieve certain functionality that is not “built-in” or already provided as a part of test environment controller's manufacture. In this sense, the test facility control system 24 is configured through software to retrofit existing test environment controllers so as to be able to carry out certain functionality that, prior to this software-based retrofitting, was not able to be carried out.

The traffic signal controller 26 is an example of a test environment controller, and is communicatively coupled to the test facility control system 24. As discussed above, the test facility control system 24 (e.g., the server 25) sends one or more test environment control messages to the test environment controllers, such as traffic signal controller 26, which then control one or more test environment devices, such as the traffic signal 28, according to the test configuration as specified by the test facility user and represented (at least in part) in the test environment control messages received from the test facility control system 24. The traffic signal controller 26 is communicatively coupled to one or more test environment devices and, in the illustrated embodiment, the traffic signal controller 26 is communicatively coupled to the traffic signal 28. In at least one embodiment, the test environment controllers can be co-located with the test environment device(s) that it controls. For example, the traffic signal controller 26 and the traffic signal 28 may be located at an intersection that the traffic signal controller 26 may control the output of the traffic signal 28 (e.g., emitting a red light, a green light, a yellow light, a blinking yellow light) based on the test environment messages received from the test facility control system 24. Also, in at least some embodiments, a test environment controller and a test environment device may share hardware components, such as the at least one processor and/or memory of the test environment controller.

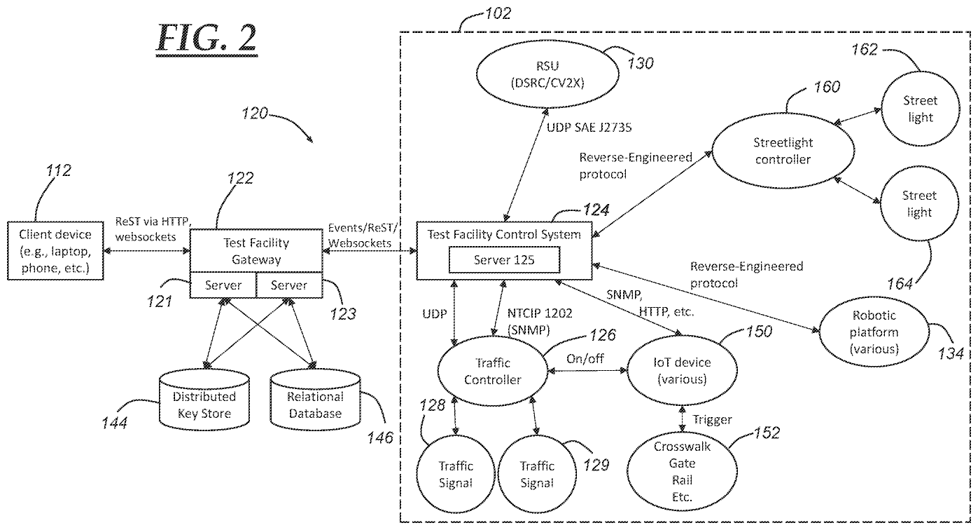

The traffic signal 28 is an example of a test environment device, which is a device located at the test facility and that is operable to change one or more vehicle environmental conditions used during testing. For example, the traffic signal 28 (an example of a first test environment device) is operable to change a traffic light, such as from emitting a green light to emitting a red light. As another example, a second test environment device is a gate that is operable to change between a road-obstructing position (or closed position) and a non-road-obstructing position (or open position). The test environment devices are communicatively coupled to at least one test environment controller, each of which is used to control the operation of test environment device(s). Although FIG. 1 depicts only a single test environment controller and a single test environment device, at least in some embodiments, the test facility infrastructure control system 20 includes a plurality of test environment controllers and/or a plurality of test environment devices, such as that which is shown in the embodiment of FIG. 2, which is described below.

Each of the test environment devices may be classified as a test environment control device or a test environment sensor device. Each of the test environment control devices may be classified as either an environmental control device or a traffic control device. An environmental control device is a test environment device that is operable to change an environmental factor or condition of the test facility, such as emitting ambient light from a streetlight or sprinkling water over a portion of the road so as to simulate rain. A traffic control device is a test environment device that is operable to change a traffic factor or condition at the test facility, such as changing a traffic light from red to green or operating a gate so as to block or open access to a road. The traffic signal 28 is considered a traffic control device. Other examples of traffic control devices include a pedestrian crossing signal, a lane control signal, a railroad crossing signal, a railroad crossing gate, a road access gate (i.e., a gate that is operable between a closed or road-obstructing position and an open or non-road-obstructing position), and a school bus operating flashing red lights and displaying a stop sign.

Each of the test environment sensor devices are one of a variety of sensors that are used to obtain sensor data concerning the test vehicle, the test environment devices, and/or other objects present at the test facility. The test environment sensor devices may include visual sensors, such as radars, cameras, and lidars, and/or may include other types of sensors, such as weather sensors (e.g., temperature sensors, precipitation sensors, humidity sensors). The test environment sensors may be configured based on the test configuration; for example, the test configuration may specify a particular period of time to record data, a particular sampling rate, or other sensor parameters. Moreover, the sensor data that is obtained by the test environment sensor devices can be stored at a remote server, such as those of the test facility gateway or other remote server that is accessible via the Internet. In at least one embodiment, the stored sensor data is made available to the test facility user via, for example, the test configuration client application 13 of the client device 12.

Additionally, each of the test environment devices may be classified as either a schedule-based test environment device or an event-based test environment device. A schedule-based test environment device is a test environment device that operates according to a predetermined or specified schedule. An event-based test environment device is a test environment device that operates in response to the detection of an event or trigger that is initiated by a vehicle, a pedestrian, other traffic at or near a road, or simulated traffic (e.g., simulated vehicles, simulated pedestrians, simulated trains). An example of a schedule-based test environment device is a traffic light that is configured to operate according to a schedule, such as a predetermined schedule or a schedule specified by a test facility user via the test facility infrastructure control system 20. An example of an event-based test environment device is a road access gate that opens when a vehicle approaches and/or when credentials of a vehicle user are verified. Another example of an event-based test environment device is a railroad crossing that is triggered upon a train (or a simulated train, which may be configured using the test facility infrastructure control system 20) approaching the railroad crossing. It should be appreciated that, at least in some embodiments, a schedule-based test environment device may, during testing, be configured to carry out certain operations in response to the system receiving a test facility configuration message from the client device. Likewise, it should be appreciated that, at least in some embodiments, an event-based test environment device may, during testing, be configured to carry out certain operations according to a predetermined schedule.

According to various embodiments, one or more of the test environment devices may be initially manufactured so as to be electronically controllable by a server (or remote electronic computer, such as the test facility control server 25) or may be initially manufactured to lack the capability of being controlled by a server (or remote electronic computer). In the latter case, standard equipment, such as a standard streetlight lacking networking capabilities, may be obtained and then modified (or retrofitted) so as to be electronically controllable by a remote server, such as the test facility control server 25. For example, an induction loop detector may be obtained and, prior to modification, may only be triggered by detecting the presence of a vehicle. The induction loop detector may then be modified (or retrofitted) to include an electronically-controllable switch that is controllable by a test environment controller so that the induction loop detector can be triggered remotely via the test facility infrastructure control system 20 in addition to its normal operation of triggering when a vehicle is detected. In one embodiment, the device (e.g., the induction loop detector) is modified to include the test environment controller that is then communicatively coupled to the test facility control system 24. In one embodiment, the device (e.g., the induction loop detector) is modified to include an Internet of Things (IoT) device that is controllable by the test facility control system 24 based on the test configuration specified by the test facility user.

The roadside unit (RSU) 30 is provided at the test facility and is used to obtain information concerning the test facility, such as the presence and/or status of vehicles. In at least one embodiment, the RSU 30 receives basic safety messages (BSMs) or other vehicle status messages from one or more vehicles at the test facility, such as the test vehicle 10. The vehicle status messages, which may be BSMs, specify certain vehicle status information, such as the location of the vehicle (e.g., a GPS location of the vehicle), the speed of the vehicle, the heading of the vehicle, and/or various other vehicle state information. The RSU 30 may also transmit traffic status messages to one or more vehicles or devices indicating a status of nearby traffic, such as the vehicle status information of other nearby vehicles. The RSU 30 may also be communicatively coupled to one or more traffic infrastructure sensors, which are sensors that capture information pertaining to traffic within the test facility. An example of a traffic infrastructure sensor is a camera that is positioned to face an intersection or road, and another example of a traffic infrastructure sensor is a radar detector that is configured to detect the speed of a vehicle. The RSU 30 is communicatively coupled to the test facility control system 24 via the local network 32 and, in some embodiments, is used to log information that is later sent to the test facility control system 24 and/or the test facility gateway 22. In at least one embodiment, the RSU 30 logs information concerning the vehicle status information that is received and/or sensor data that is obtained by the traffic infrastructure sensors. In another embodiment, the RSU 30 forwards the information concerning the vehicle status information to the test configuration client application 13 of the client device 12, which can then present the information to the test facility user, which can enable the test facility user to trigger certain events at the test facility based on the feedback provided by the information. Also, although only a single RSU is shown, the test facility infrastructure control system 20 may include a plurality of RSUs.

Any one or more of the processors discussed herein (e.g., the at least one processor of the client device 12, the test facility gateway 22, the test facility control system 24, the traffic signal controller 26) can be any type of device capable of processing electronic instructions including microprocessors, microcontrollers, host processors, controllers, vehicle communication processors, field-programmable gate arrays (FPGAs), and application specific integrated circuits (ASICs). The processors may execute various types of digitally-stored instructions, such as software or firmware programs stored in the memory, which enable the facility to provide a wide variety of services. For instance, one or more of the processors of the test facility infrastructure control system 20 may be configured to execute programs or process data to carry out at least a part of the method discussed herein. In one embodiment, one or more of the processors of the test facility infrastructure control system 20 may execute an application (e.g., computer program) that causes the processor to perform one or more of the method steps using information or data that is received from the client device 12 or other device of the communications system 1. Any one or more of the memory discussed herein (e.g., the memory of the client device 12, the test facility gateway 22, the test facility control system 24) can include powered temporary memory and/or any suitable non-transitory, computer-readable medium such as different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives, or other suitable memory.

With reference to FIG. 2, there is shown another embodiment of a test facility infrastructure control system 120. The test facility infrastructure control system 120 includes a test facility gateway 122 having a plurality of test facility gateway servers 121, 123, a test facility control system 124 having a test facility control server 125, a plurality of test facility controllers (which is represented in FIG. 2 by a traffic controller 126, a streetlight controller 150, an IoT device 160, and a controller of a robotic platform 134), a plurality of test environment devices (which is represented in FIG. 2 by a first traffic signal 128, a second traffic signal 129, a first streetlight 152, a second streetlight 154, an electromechanical device of the robotic platform 134), and a roadside unit (RSU) 130. The discussion of the embodiment of FIG. 1 applies to the embodiment of FIG. 2 to the extent such discussion is not inconsistent with the discussion of the embodiment of FIG. 2. For example, the discussion of the test facility gateway 22 applies equally to the test facility gateway 122 to the extent such discussion of the test facility gateway 22 is not inconsistent with the discussion of the test facility gateway 122.

The client device 112 is communicatively coupled to the test facility gateway 122 via a ReST (HTTP) or websockets connection as illustrated in FIG. 2, although it should be appreciated that other communication protocols may be used. The client device 112 may include a test configuration client application (not shown) that communicates with the test facility gateway 122, such as through sending one or more test facility configuration messages. The test facility gateway 122 includes a plurality of test facility gateway servers 121, 123, as well as a plurality of databases including a distributed key store 144 and a relational database 146. The distributed key store 144 is used to store states of the test facility (referred to as test facility state information), which may be received from the test facility control system 124. For example, vehicle status information of the test vehicle 10 (i.e., an example of test facility state information) that is received at the test facility control system 124 from the RSU 130 may then be sent to the test facility gateway 122 and stored at the distributed key store 144. The distributed key store 144 is a distributed database that stores key-value pairs. The relational database 146 includes one or more database tables that are accessible and/or modifiable using structured query language (SQL) or other suitable database interfacing languages and/or protocols. In one embodiment, the distributed key store 144 is used to store test facility state information and the relational database 146 is used to store test facility account information (e.g., username, credentials, pre-stored test configuration data, authorization schedule data). However, additionally or alternatively, the distributed key store 144 may store test facility account information and/or the relational database 146 may store test facility state information. Also, although only a single distributed key store and a single relational database are shown in FIG. 2, it should be appreciated that any suitable number of distributed key stores and relational database may be used. Also, it should be appreciated that, in other embodiments, other types of databases may be used in lieu of or in addition to the distributed key store 144 and/or the relational database 146.

As shown in the illustrated embodiment of FIG. 2, the test facility control system 124 and the test facility gateway 122 may be connected via a Server-Sent Events (SSE), a Representational State Transfer (ReST) (HTTP), or a websockets connection, although it should be appreciated that other communication protocols and/or technologies may be used. The RSU 130 includes cellular vehicle to infrastructure (C-V2X) technology, which may be implemented by a wireless circuitry or chipset. The communications of the RSU 130 that use the C-V2X technology can include direct communications or those that use one or more wireless communication towers. Additionally or alternatively, the RSU 130 can use dedicated short-range communication (DSRC) technology (also referred to as short-range wireless communication (SRWC)), which may be implemented using short-range wireless communications (SRWC) circuitry, such as a wireless electromagnetic transceiver capable of communicating via Wi-Fi™, IEEE 802.11p, or other suitable wireless communication protocol, for example. The RSU 130 is shown as being communicatively coupled to the test facility control system 124 via a UDP connection according to SAE J2735; however, it should be appreciated that other protocols and/or communication technologies can be used.

The test facility control system 124 is located at the test facility 102, and is connected to a plurality of test environment controllers, including the traffic controller 126, the streetlight controller 150, and an electronic controller that is part of the robotic platform 134. The traffic controller 126 is communicatively coupled to the test facility control system 124 via two separate connections, including a UDP connection and a NTCIP 1202 (SNMP) connection. The traffic controller 126, which is an example of a test environment controller, is communicatively coupled to the first traffic signal 128 and the second traffic signal 129. The first traffic signal 128 and the second traffic signal 129 may be located at the same intersection, along with the traffic controller 126. In other embodiments, the traffic controller 126 may control traffic signals at more than one location or intersection. The traffic controller 126 may also be used to control other test environment devices, such as a pedestrian crossing signal.

The IoT (Internet of Things) device 160 (only one shown, but a plurality may be used) is a device that is capable of communicating with one or more local or remote networks, such as the local network 32 and/or the land network 14. The IoT device 160 is shown as being communicatively coupled to the test facility control system 124 via SNMP or HTTP, however, it should be appreciated that other protocols may be used. Each of the IoT devices, including IoT device 160, may be a test environment controller and/or may be communicatively coupled to one or more test environment controllers, such as the traffic controller 126 as shown in FIG. 2. The IoT device 160 may include an electronically-controllable switch, as well as a communications device (e.g., which can have a telematics unit, a modem, and/or a network interface card and/or circuitry). The IoT device 160 may be retrofitted into a standard device 162 so that the IoT device 160 may control certain functionality of the standard device 162. For example, the standard device 162 is a physical pushbutton that is provided at or near a pedestrian crosswalk and that is used to control a pedestrian crossing signal; in such a scenario, this pedestrian crossing signal may only be controllable using the physical pushbutton, but in order to make the pedestrian crossing signal remotely controllable based on the test configuration, the pedestrian crossing signal may be retrofitted or otherwise modified so as to incorporate the IoT device 160. The IoT device 160 as incorporated into the pedestrian crossing signal thus provides a test environment device that is controllable by a test environment controller. In one embodiment, the IoT device 160 may include or constitute a test environment controller and may communicate with the test facility control system 124 so as to control the test environment device (e.g., the modified pedestrian crossing signal). In one embodiment, the IoT device 160 is used to trigger an operation of an event-based test environment device, such as a pedestrian crosswalk signal, based on operating according to the test configuration. For example, where the test configuration specifies that a pedestrian crosswalk pushbutton is triggered at a particular time, the IoT device 160 (or a test environment controller) may detect an occurrence of the trigger and cause the IoT device 160 to operate its electronically-controllable switch that is incorporated into the pedestrian crosswalk button/system so as to simulate a pedestrian pressing the pedestrian crosswalk button/system, which may then cause the pedestrian crosswalk signal to change. Also, in some embodiments, the IoT device 160 (or other IoT devices) include one or more sensors that can be used to monitor objects or the environment at the test facility. In one embodiment, the IoT device 160 (or other IoT devices) include one or more sensors in addition to a switch that this used to control a test environment device.

The streetlight controller 150 is another example of a test environment controller and is used to control a first streetlight 152 and a second streetlight 154, each of which is considered a test environment device and, specifically, an environmental control device. The streetlight controller 150 is communicatively coupled to the test facility control system 124 via a reverse-engineered protocol. The first streetlight 152 and the second streetlight 154 provide ambient lighting to a portion of the test facility 102, and these streetlights 152 and 154 may be controlled based on the test configuration.

The robotic platform 134 represents any of a number of test environment devices that are robotic (i.e., capable of motion), such as an automated or autonomous passenger car (or other vehicle) or a robotic dummy that may be deployed to a portion of a road of the test facility (or other portion of the test facility) for purposes of testing and that may be used to simulate the presence of a deer or pedestrian in the road or other portion of the test facility. In particular, the robotic dummy is a test-anomaly device, which is a test environment device that is used to introduce the presence of anomalous conditions, such as the presence of an animal or pedestrian on the road at a non-designated area and/or at a non-designated time, such as at a portion of the road that is not a pedestrian crosswalk or at a time when the pedestrian crosswalk signal is red (or set to DO NOT CROSS). The robotic platform 134 includes a test environment controller that controls the functionality or operation of a test environment device, such as the deployable robotic dummy described above, according to the test configuration. The robotic platform 134 includes one or more electromechanical devices that are considered a test environment device and that are controllable by the test environment controller of the robotic platform 134. The robotic platform 134 is communicatively coupled to the test facility control system 124 via a reverse-engineered protocol.

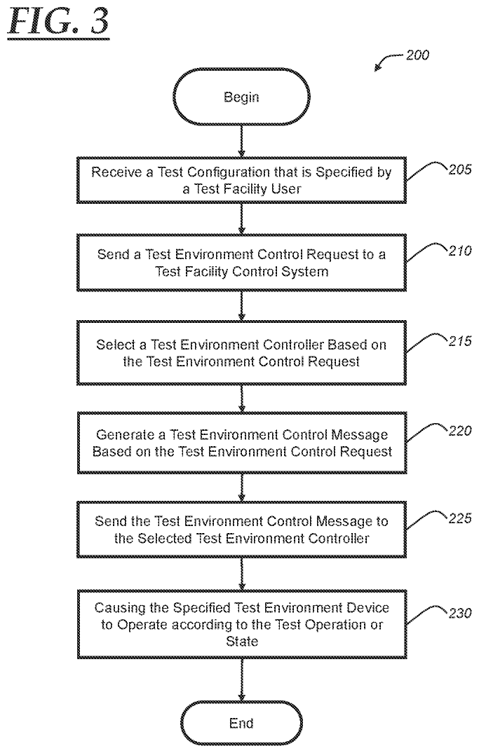

With reference to FIG. 3, there is shown an embodiment of a method 200 of controlling a test environment device of a test facility based on a test configuration. The method 200 is carried out by a test facility infrastructure control system, such as the test facility infrastructure control system 20 or the test facility infrastructure control system 120. Although the steps of the method 200 are described below as being in a particular order, it is hereby contemplated that the steps of the method 200 may be carried out in any technically feasible order.

The method 200 begins with step 205, wherein a test configuration that is specified by a test facility user is received. In one embodiment, the test configuration specifies one or more state of one or more test environment devices and, in a particular embodiment, specifies a single state (or operation) for a single test environment device, which can be used to test individual functionality of the system 20. However, in other embodiments, the test environment device specifies a plurality of various states for a plurality of various test environment devices, and may be used to orchestrate a test that is used to test the test vehicle's responsiveness to a variety of different environmental conditions and traffic conditions, and which may simulate a real-world scenario. In one embodiment, the test facility user uses the test configuration client application 13 of the client device 12 to input information specifying a test configuration that is to be used for testing at the test facility. In such embodiments, the client device 12 can include one or more human-machine interfaces (HMIs), such as a touchscreen display or pushbuttons, which enable the test facility user to input the information specifying the test configuration. The client device 12 then sends one or more test facility configuration messages, which contain information specifying the test configuration, to the test facility gateway 22, which receives the one or more test facility configuration messages specifying the test configuration.

At least in some embodiments, the client device 12 sends messages to the test facility gateway 22 according to a defined application programming interface (API) (referred to as the “test configuration API”) that is provided by the test facility gateway 22. The test configuration API may be, for example, a Representational State Transfer (ReST) web API. Additionally or alternatively, the test configuration API uses websockets for communications between the test facility gateway 22 and the client device 12 that communicate using the test configuration API. In one embodiment, the test facility gateway 22 may store a previous test configuration as pre-stored test configuration data, which may be recalled by a particular test facility user. For example, the test facility user may specify a test configuration using the client device 12, which may then store test configuration data into memory (e.g., memory of relational database 146). Then, for example, at a later time, this pre-stored test configuration data is recalled and used to indicate or specify the test configuration. In one embodiment, the test facility gateway 22 stores usernames, passwords, other credentials, or other authorization or identifying information of a plurality of test facility users. Then, through use of the test configuration API, for example, a test facility user may indicate their account and any pre-stored test configuration data that is associated with their account may be recalled and provided to the test facility user, who may then indicate whether to load or use a particular test configuration that is stored as associated pre-stored test configuration data. The method 200 then continues to step 210.

In step 210, a test environment control request is sent to a test facility control system. The test environment control request specifies at least one of the test environment devices and includes test environment control instructions that specify a test operation or state of the specified test environment device. The test environment control instructions are generated by the test facility gateway based on the test configuration that is specified by the test facility user. In at least some embodiments, the test environment control request is sent from the test facility gateway 22 to the test facility control system 24. The method 200 then continues to step 215.

In step 215, a test environment controller is selected based on the test environment control request. In at least one embodiment, the one or more test environment controllers that are used for controlling the specified test environment devices are selected. As mentioned above, the test environment control requests may specify a test environment device and, then, the test environment controller that is used to control that specified test environment device is selected. In some embodiments, a plurality of test environment controllers are selected based on the test environment control message. The method 200 then continues to step 220.

In step 220, a test environment control message is generated based on the test environment control request. The test environment control message specifies the test operation or state of a test environment device, such as the test environment device that was specified in the test environment control request. In at least one embodiment, the test facility control system generates the test environment control message and, in one embodiment, the test environment control message is generated based on a selected test environment controller (see step 215). Also, in some embodiments, the test environment control message is configured according to certain specifics of the test environment controller so that, when the test environment control message is received by the test environment controller, the test environment controller causes the specified test environment device to operate according to the test operation or state. In this way, the test environment controller causes the test environment device to operate according to the test configuration that was specified by the test facility user. The method 200 continues to step 225.

In step 225, the test environment control message is sent to the selected test environment controller. In at least one embodiment, the test environment control message is sent from the test facility control system 24 to the test environment controller (e.g., the traffic signal controller 26) via the local network 32. Additionally or alternatively, other test environment control messages may be sent via the land network 14 and/or wirelessly using V2X communications, which may include communications sent over the Internet. The particular protocol used to send the test environment control message may be determined based on the particulars of the selected test environment controller, such as based on the protocols or other settings that the selected test environment controller is configured to use. The method 200 continues to step 230.

In step 230, the test environment controller causes the specified test environment device to operate according to the test operation or state as specified in the test environment control instructions of the test environment control request. For example, the test environment control instructions may specify that the traffic signal 28 is to be set to a RED phase (i.e., emitting a red light) for a period of 25 seconds starting at 12:02 PM and thereafter to a GREEN phase (i.e., emitting a green light). In such an example, the traffic signal controller 26 (i.e., in this example, the test environment controller) then carries out operation(s) that cause the traffic signal 28 to emit the red light (or to be set to the RED phase) for a period of 25 seconds starting at 12:02 PM and, thereafter to emit a green light (or be set to the GREEN phase). Then, in response to receiving the test environment control message, the traffic signal controller 26 may set a trigger for 12:02 PM that, when triggered (i.e., when the time becomes 12:02 PM), directs the traffic signal 28 to emit red light and, at such time, the traffic signal controller 26 then starts a timer for 25 seconds and, at the end of the timer (i.e., at the expiration of the 25 seconds), the traffic signal controller 26 causes the traffic signal 28 to emit green light. In another embodiment, the scheduling of the trigger and/or other operations (e.g., the setting and detecting of the end of the alarm) may be implemented or carried out by the test facility control system 24 and, in such a scenario, for example, the test facility control system 24 may send test environment control messages to the traffic signal controller 26 so as to operate the traffic signal 28 according to the test operation or state as specified in the test environment control instructions of the test environment control request. For example, the test facility control system 24 may monitor the time and, at 12:02 PM, may send a test environment control message to the traffic signal controller 26 that causes the traffic signal 28 to emit a red light and, then at the expiration of the 25 second timer, the test facility control system 24 may send another test environment control message to the traffic signal controller 26 that causes the traffic signal 28 to emit a green light. As another example, the trigger may be triggered in response to one or more predetermined states of the vehicle, such as when the vehicle arrives at a certain location, accelerates to a particular speed, operates brakes or headlights, etc. The method 200 then ends.

In some embodiments, the method may further include storing test facility state information into memory, such as into memory of the distributed key store 144. Also, in one embodiment, the test facility gateway 122 is connected to the test facility control system 124 via a remote connection and the test facility gateway 122 may receive test facility state information over this remote connection. Also, it should be appreciated that the test facility gateway 122 is connected to the test facility control system 124 may be connected via a web sockets connection (or other suitable connection (e.g., TCP, UDP)), which enables the test facility gateway 122 to observe changes in data (e.g., the test facility state information) as those changes are made or recorded at the test facility control system 124. In at least some embodiments, the test facility state information is made available to the test facility user, such as via the test configuration client application 13 on the client device 12.

In some embodiments, prior to step 205, the test facility gateway 122 determines whether a particular test facility user is authorized to set a test configuration and/or to access certain data from the test facility gateway 122. In some embodiments, the test facility user may have access to, and/or be able to configure a test configuration for, the test facility 102 during particular times, which can be represented by authorization schedule data that may be stored at relational database 146 or other database or memory of the test facility gateway 122. In one embodiment, the test facility gateway 122 may only allow access to certain information from the test facility gateway when the test facility user is authorized (e.g., via a username and password), which may be determined based on test facility user credentials along with the authorization schedule data.

It should be appreciated that the test facility may include one or more test sites, which are independent locations within the test facility that are each used for vehicle testing. The test environment devices may be located at one of the test site(s) and, in the case of robotic test environment devices, the robotic test environment devices may be controllable so as to move between test sites.

In some embodiments, any one or more steps of the method discussed herein are embodied on one or more computer-readable mediums, such as any of those suitable types of memories discussed herein. The one or more steps of the method can be implemented or embodied as computer instructions on the one or more computer-readable mediums, which can then be executed by one or more processors, such as any combination of the processors discussed herein, including, for example, one or more processors of the test facility gateway 22, the test facility control system 24, and/or the test environment controllers.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A test facility infrastructure control system for controlling test environment devices located at a test facility, comprising:
at least one test facility control server that includes at least one processor and memory storing computer instructions, wherein the at least one test facility control server is communicatively coupled to a test facility gateway server that is configured to receive test facility configuration information that specifies a test configuration to be used in carrying out vehicle testing at the test facility;
a plurality of test environment devices located at the test facility, each of the test environment devices being operable to change one or more vehicle traffic or environmental conditions used during the vehicle testing; and
one or more test environment controllers, each of which is communicatively coupled to at least one of the test environment devices, and each of which is communicatively coupled to the at least one test facility control server;
wherein, when the computer instructions are executed by the at least one processor, the at least one test facility control server is configured to:
receive a test environment control request from the test facility gateway server, wherein the test environment control request specifies at least one of the test environment devices and includes test environment control instructions that specify a test operation or state of the specified test environment device, and wherein the test environment control instructions are generated by the test facility gateway server based on the test configuration; and
send a test environment control message to a selected one of the one or more test environment controllers, wherein the test environment control message specifies the test operation or state of the specified test environment device, and wherein the selected test environment controller is configured to, in response to receiving the test environment control message, cause the specified test environment device to operate according to the test operation or state so as to operate according to the test configuration.

2. The test facility infrastructure control system of claim 1, wherein the test facility gateway provides a test configuration application programming interface (API) that is used by a client device of a test facility user to specify the test configuration.

3. The test facility infrastructure control system of claim 2, wherein the client device includes a test configuration client application, wherein the test configuration client application provides a graphical user interface (GUI) that is usable by the test facility user for specifying certain properties or portions of the test configuration.

4. The test facility infrastructure control system of claim 1, wherein at least one of the one or more test environment controllers is a traffic signal controller and at least one of the plurality of test environment devices is a traffic signal that is controllable by the traffic signal controller.

5. The test facility infrastructure control system of claim 4, wherein the test configuration specifies a traffic signal state of the traffic signal, wherein the test environment control message specifies the traffic signal state of the traffic signal, and wherein, when the traffic signal controller receives the test environment control message, the traffic signal controller causes the traffic signal to operate according to the traffic signal state.

6. The test facility infrastructure control system of claim 1, wherein the test facility infrastructure control system further includes a roadside unit that is communicatively coupled to the test facility control system and that is capable of short-range wireless communications (SRWCs), and wherein the RSU receives vehicle state information from a test vehicle that is being tested at the test facility and sends the vehicle state information to the test facility control system.

7. The test facility infrastructure control system of claim 6, wherein the vehicle state information is sent to a client device of a test facility user and presented to the test facility user using a human-machine interface (HMI) of the client device.

8. The test facility infrastructure control system of claim 1, wherein the test facility gateway server is part of a test facility gateway, and wherein the test facility gateway records test facility state information into a database.

9. The test facility infrastructure control system of claim 8, wherein the test facility state information is received at the test facility gateway from the at least one test facility control server, and wherein the database is a distributed key store that stores key-value pairs.

10. The test facility infrastructure control system of claim 1, wherein at least one of the plurality of test environment devices is a traffic control device that is retrofitted with an internet of things (IoT) device so as to enable the retrofitted traffic control device to be remotely controllable by the test facility infrastructure control system.

11. The test facility infrastructure control system of claim 1, wherein at least one of the plurality of test environment devices is a test-anomaly device that is used to introduce anomalous conditions into the test facility.

12. The test facility infrastructure control system of claim 11, wherein the test-anomaly device is a robotic dummy that is deployable to a portion of a road within the test facility.

13. The test facility infrastructure control system of claim 1, wherein at least one of the plurality of test environment devices is an environmental control device that is operable to change an environmental factor or condition of the test facility.

14. The test facility infrastructure control system of claim 13, wherein the environmental control device is a streetlight that provides ambient lighting to a portion of the test facility.

15. The test facility infrastructure control system of claim 1, wherein at least one of the plurality of test environment devices is a schedule-based test environment device that operates according to a predetermined or specified schedule that is specified at least in part by the test configuration.

16. The test facility infrastructure control system of claim 1, wherein at least one of the plurality of test environment devices is an event-based test environment device that operates in response to detection of a trigger that is specified at least in part by the test configuration.
